(19) United States
(12) Patent Application Publication
(10) Pub. No.: US 2007/0283258 A1
(43) Pub. Date: Dec. 6, 2007

(54) User-implemented handwritten content in a recursive browser system

(76) Inventor: Joseph Pally, Katy, TX (US)

Correspondence Address: Benjamin Aaron Adler;ADLER & ASSOCIATES, 8011 Candle Lane, Houston, TX, 77071, US

(21) Appl. No.: 11/445,389

(22) Filed: May 31, 2006

(51) Int. Cl. G06F 15/00

(52) U.S. Cl. 715/541

(57) ABSTRACT

Provided herein is a recursive browser system including a recursive web browser and a unit for handwriting content within the recursive browser window. The handwriting may be written from user-created VML-formatted handwriting objects or derived from typed text mapped to user-created VML-formatted handwriting objects. Also provided is a computer-implemented method for handwriting content within a recursive browser environment.

### COMPUTER PROGRAM LISTING APPENDIX

Computer program listings are submitted on compact disc in compliance with 37 C.F.R. §1.96 and are incorporated by reference herein. A total of two (2) compact discs (including duplicates) are submitted herein. The files on each compact disc are listed below:

| Files | Size (KB) | Date Created |
|---|---|---|
| RecursiveBrowserCode.txt | 40 | May 29, 2006 |
| zBox.txt | 48 | May 29, 2006 |
| Handwriting.txt | 76 | May 29, 2006 |

### BACKGROUND OF THE INVENTION

1. Field of the Invention

The present invention relates generally to the fields of computer technology and web browser systems. More specifically, the present invention provides a system and method for a user to create handwritten content within a recursive browser environment.

2. Description of the Related Art

The Internet is arguably the most important innovation of the computer generation. To browse or surf the World Wide Web (the Web) is the fastest and most popular method of obtaining information today. However, current web browsers are primarily read only with little interactive capability. The Internet is “go to and visit” and not part of the experience. A user's experience on the Internet is a temporal series of URLs visited.

In addition most users are interested only in snippets of a web site they visit. However, a user must open a word processing, drawing or similar application or access another website to utilize or build on these snippets, if desired, or, for example, to create a document or image de novo. Browsers lack the ability allowing users to create and to integrate de novo content within the browser window.

Creating a new browser to address these problems is not an easy solution. It is estimated that a new browser release can cost from $10 million to $100 million. In addition the development and release processes are extremely time consuming. As such, one solution is to use the browser itself to expand browser functionalities.

Thus, there is a significant need in the art for improvements in the area of user-driven experiences. Specifically, the present invention is deficient in systems and methods to create, display and manipulate handwritten content in a recursive browser environment. The present invention fulfills this long-standing need and desire in the art.

### SUMMARY OF THE INVENTION

The present invention is directed to a computer system. The computer system comprises a recursive web browser configured to recursively display one or more pages of content within a browser window thereof; a device adapted for user-implemented handwriting or drawing; and a unit for handwriting cursive script or drawing within the browser window. In a related invention the computer system further comprises means for launching a user-requested address or action. In another related invention the computer system further comprises means for displaying the visible handwriting or drawing as a zPage or as a zBox or a combination thereof within the browser window and means for saving the handwriting or drawing to a server, as a local file, or as an email.

The present invention also is directed to a recursive browser system. The recursive browser system comprises a recursive web browser configured to recursively display one or more pages of content in a browser window thereof and a unit for handwriting cursive script or drawing within the browser window. In related inventions the recursive browser system further comprises the means for displaying and saving the zBox or zPage as described herein.

The present invention is directed further to a recursive web browser. The recursive web browser comprises a browser window configured to recursively display one or more pages of content therewithin, means for launching a user-requested address or action and a unit for handwriting cursive script or drawing within the browser window. As described herein the recursive web browser further comprises means for displaying and saving the zBox or zPage.

The present invention is directed further still to a computer-implemented method for handwriting content in a recursive browser environment. The computer-implemented method comprises implementing a user-created handwriting object within the recursive browser window described herein, storing the user-implemented handwriting object as a VML-, VRML- or SVG-formatted array representing points and hiding the handwriting object. and time-releasing One or more points comprising the array are time-released as visible handwriting. In a related invention, the method further comprises creating a plurality of VML-, VRML- or SVG-formatted handwriting objects and mapping a typed text to the formatted handwriting objects.

Other and further aspects, features and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIGS. 1A-1B are flowcharts depicting writing the handwriting processes whereby a user handwrites content (FIG. 1A) or matches text to a collection or template of handwritings (FIG. 1B).

FIGS. 2A-2C illustrate the writing the handwriting playback within a recursive browser window.

### DETAILED DESCRIPTION OF THE INVENTION

In one embodiment of the present invention there is provided a computer system, comprising a recursive web browser configured to recursively display one or more pages of content within a browser window thereof; a device adapted for user-implemented handwriting or drawing; and a unit for handwriting cursive script within the browser window. In this embodiment an example of the writing implementable device is a mouse, a stylus or a keyboard.

Further to this embodiment the computer system may comprise means for launching a user-requested address or action. The launching means may be an action bar within the recursive browser window or an address bar located in a browser platform associated with the recursive web browser which triggers the action bar. Also, in another further embodiment, the computer system may comprise means for displaying the visible handwriting or drawing as a zPage or as a zBox or a combination thereof within the browser window. Further yet to these embodiments the computer system may comprise means for saving the handwriting or drawing to a server, as a local file, or as an email.

In one aspect of all these embodiments the handwriting unit may comprise a process for storing a user-created handwriting or drawing object as a VML-, VRML- or SVG-formatted array representing points. Furthermore the unit may comprise a process for hiding the object. Further still, the handwriting unit may comprise a process for time-releasing one or more points comprising the array as visible handwriting or drawing within a browser window. In another aspect, the handwriting unit additionally may comprise a plurality of stored VML-, VRML- or SVG-formatted handwritings whereby the unit further comprises a process for mapping a typed text to the formatted handwritings. Examples of a typed text may be a user-implemented typed text or retrieved typed text.

In another embodiment of the present invention there is provided a recursive browser system, comprising a recursive web browser configured to recursively display one or more pages of content in a browser window thereof; and a unit for handwriting cursive script or drawing within the browser window. Further to this embodiment the recursive browser system may comprise the means for launching a user-requested address or action, the means for displaying the visible handwriting or drawing and the means for saving the handwriting or drawing, as are described supra.

In all these embodiments the unit may comprise a process for storing a user-created handwriting or drawing object as a VML-, VRML- or SVG-formatted array representing points; a process for hiding the object; and a process for time-releasing one or more points comprising the array as visible handwriting or drawing within a browser window. Further to all these embodiments, the recursive browser system may comprise a plurality of stored VML-formatted handwritings where the handwriting unit further comprises a process for mapping a typed text to the VML-formatted handwritings.

In yet another embodiment of the present invention there is provided a recursive web browser, comprising a browser window configured to recursively display one or more pages of content therewithin; means for launching a user-requested address or action; and a unit for handwriting cursive script or drawing within the browser window. In this embodiment the examples of the launching means and the processes comprising the unit are as described supra. Further to this embodiment the recursive web browser may comprise the means for displaying the visible handwriting or drawing and the means for saving the handwriting or drawing as described supra.

In yet another embodiment of the present invention there is provided a computer-implemented method for handwriting content in a recursive browser environment, comprising implementing a user-created handwriting object within the recursive browser window described supra, storing the user-implemented handwriting object as a VML-, VRML- or SVG-formatted array representing points; hiding the handwriting object; and time-releasing one or more points comprising the array as visible handwriting.

Further to this embodiment the method may comprise creating a plurality of VML-, VRML- or SVG-formatted handwriting objects; and mapping a typed text to the formatted handwriting objects. In this further embodiment the typed text may be a user-implemented typed text or a retrieved typed text.

As used herein, the term “a” or “an” may mean one or more. As used herein in the claim(s), when used in conjunction with the word “comprising”, the words “a” or “an” may mean one or more than one. As used herein “another” or “other” may mean at least a second or more of the same or different claim element of components thereof.

As used herein, the term(s) “recursive browser” or “zBrowser” refers to a browser that uses existing browsers to enhance their functionality and to provide 3 dimensional multipart full browser functionality to improve browser experience

As used herein, the term “Action Bar” refers to a targeting bar, which may be the conventional URL bar, that can also be triggered from html or a href calls invoking, e.g., one or more web actions, web sites, web services, or action triggers.

As used herein, the term(s) “zBox” refers to a part of a zPage that contains an html object(s), for example, but not limited to, images, scripts, shockwave, and a recursive browser. zBoxes are copiable and individually and selectively formattable with drag-drop of style text.

As used herein, the term(s) “zPage” or “zBrowser page” refers to a container of zBoxes that encompasses logic to display, edit, move, browse, and run scripts within the recursive browser. Parts of a zPage are copiable and individually and selectively formattable with drag-drop of style text. A zPage can be controlled by Zebra, i.e. zBox algebra, and is composed from data (that could be stored separately) with logic coming from the zCube server files. zPage can receive and conduct Jumping-Jax (dynamically obtained server based javascripts), effecting dynamic page maintainance.

As used herein, the term(s) “zEditor” refers to a zPage that is a page, either local or on the web, primarily composed of HTML, which allows parts of the page, e.g., z-boxes, which may be shared by groups of users, groups of z-boxes, window layer, or background-layer, to be selected, edited, or dragged-and-dropped, to effect creation of new objects upon demand, by dragging-dropping, double-clicking, or pasting, based on instructions of the incoming HTML or script of diverse media, to receive events from and into individual zBoxes and routing them, to contain zBrowser(s), VML, SVG or other handdrawings/handwritings with pointers to remote or local z-boxes or with individually addressable z-boxes or controls.

As used herein, the term(s) “zCube” refers to sets of Pages/zNotes along with contained content/objects. A zCube may be made from templates that are stored in a gallery.

As used herein, the term(s) “zCube world” refers to collections of zCubes that comprise a user-driven browser/editor experience. A zCube world may contain zPages.

The present invention provides a system and method for creating and displaying handwritten content within a recursive browser environment in real time. The system and method disclosed herein utilize zCubes which is a thin web-browser based environment. The zCubes environment has the capabilities of a fully functional browser, a web content editor, handwriting and drawing, photo management, multi-media integration, JS scripting, QJax for client driven calls, and Jumping Jax for server driven calls. A zCubes environment allows a user to manage content, including user-implemented handwritten or hand drawn content, and to integrate a wide variety of media.

The recursive browser comprises an Action Bar within the zBrowser window or page as an entry point for any retrievable URL or executable action trigger within the zBrowser environment. The zBrowser is enabled to recursively display one or more zPages within the browser window whether containing content or blank. Furthermore, using the Action Bar, a user may interact or create within a zPage or may open one or more zBoxes within zPage(s) and create a handwritten content therewithin using cursive script or hand drawn content.

As such, the recursive browser environment comprises an editing functionality, or zEditor, which provides means for a user to create his own web content, i.e., a user has the ability to compose in a manner similar to handwriting using a device adaptable as a writing implement, for example, the mouse, stylus or keyboard, or any other input medium or to draw an object freehand using the same. Alternatively, the user may create a freeform drawing or incorporate both handwriting and drawing into the zPage(s). The created handwritten object or drawing may be saved as a webpage or zPage for reading using a thin web browser. 2-D and 3-D objects may be created and subsequently moved and/or resized using zCubes without help from activeX or other embedded media. This technology may use VML, VRML or SVG. Furthermore, the handwritings or drawings may be edited as they are being created and after they are saved due to zEditor functionality within the recursive browser system. The created web content, such as fully handwritten and/or handdrawn pages, can become part of the zPage or a zCube world and can be saved to a server as internet files, saved as a local file, or saved as email or stored on any other utilizable computer storage medium known and standard in the art.

One or more zBoxes float and function within a zCubes world. A zCube world is contained within a recursive web page, i.e., a zPage or document, or a zDoc. It is contemplated that each zPage could be later considered as a hierarchy of zCubes world due to the recursive containment within the browser window. A zCubes world is stored and retrieved therefrom. Both zBoxes and zPages comprising user-implemented handwritten or handdrawn content have a lifecycle where each are at least able to be created, edited, saved, retrieved or deleted.

As described herein, the invention provides a number of advantages and uses. Embodiments of the present invention are better described below with reference to the Figures, however, such description or reference is not meant to limit the present invention in any fashion. The embodiments and variations described in detail herein are to be interpreted by the appended claims and equivalents thereof.

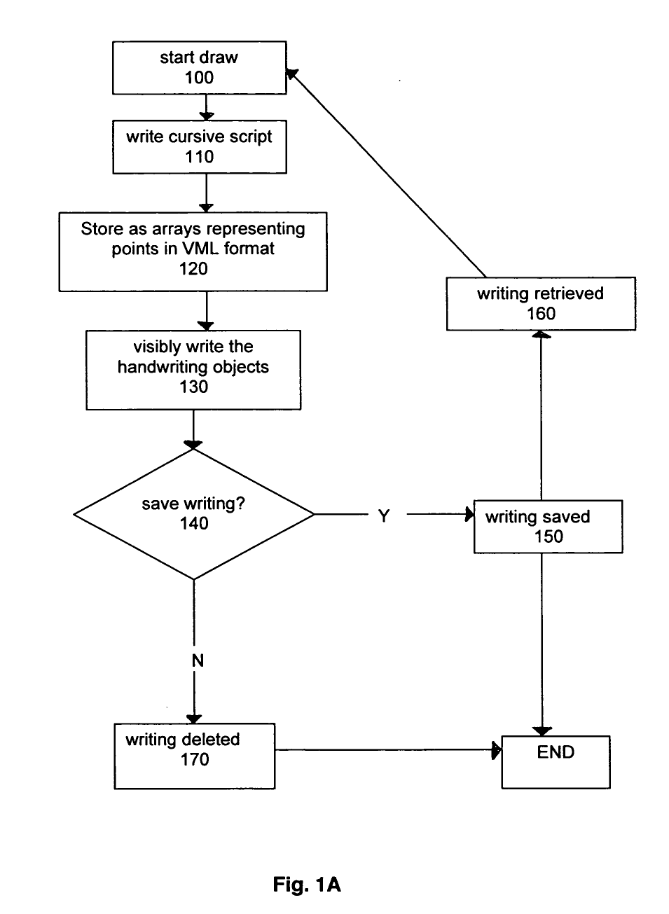

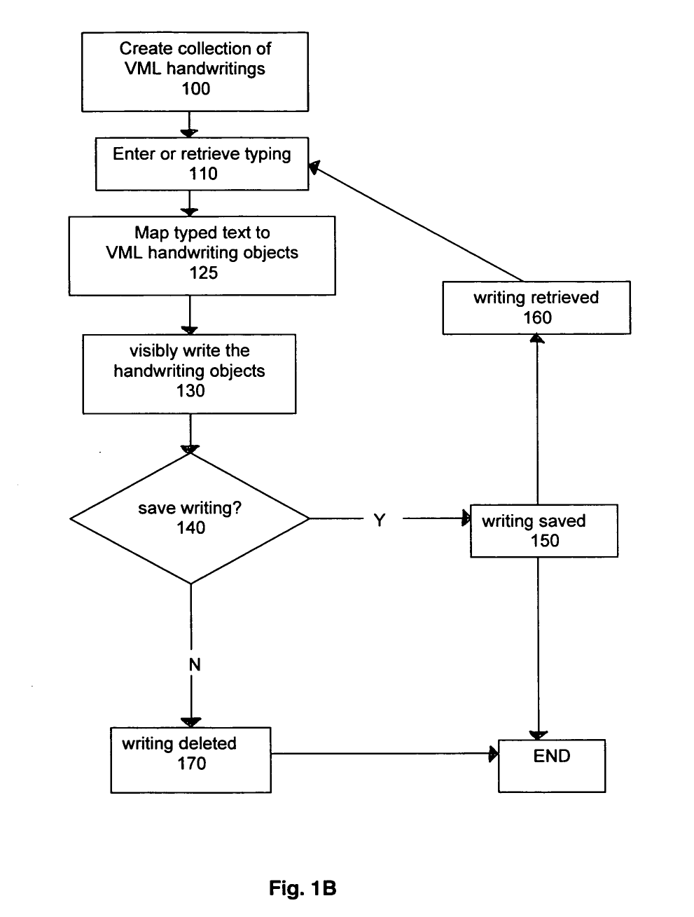

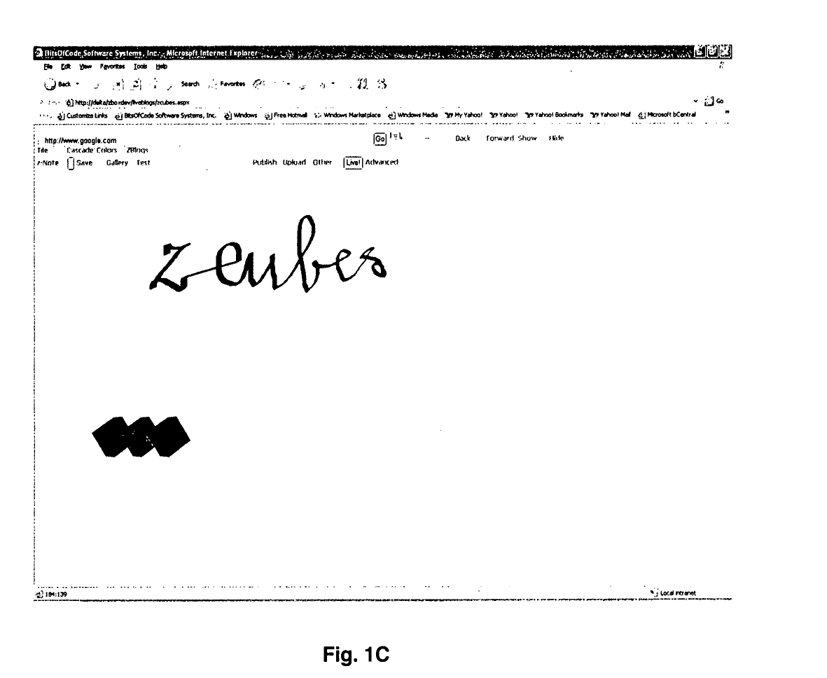

FIG. 1A is a flowchart illustrating a de novo user-created handwriting process. At step 100, the user opens a zBox or zPage and clicks on start to draw. The user may then write a freeshape line, such as but not limited, a cursive handwriting or other line drawing at 110. The handwriting may be of any length because zCubes enables infinite page size. At step 120 the user-created handwriting is stored in VML format as arrays representing points. In a “writing the handwriting” process, at step 130, the handwriting object is hidden whereby the array points are released sequentially using a timer thus making the handwriting or free form line visible. This causes a ghost-hand to write the handwriting into the page.

At step 140, the user may decide to save the visible writing or to delete it. Thus, these added lines or handwritings become part of the zpage/zcube and can be saved retrievably to the server, to a local file or can be emailed at 150 which may end the handwriting process. Subsequently, a user may open another zBox or zPage and start the handwriting process again or retrieve saved handwritings at step 160 and edit the handwritten content. Alternatively, at step 170 the user may delete the zBox or zPage comprising the handwritten content or delete only the handwritten content thereby also ending the handwriting process.

With continued reference to FIG. 1A, FIG. 1B is a flowchart illustrating an alternative handwriting process. In this process, at step 105, the user may create a collection of VML handwritings using zcubes or may utilize good handwritten alphabet collections as a template. Then, at step 115, opens a zBox or zPage and types therein or opens a file or content. At step 125, the typed text is converted into a collection of VML objects by mapping into the VML handwriting objects. As in FIG. 1A, at step 130, the typed text is written as handwritten text in real time through a timer point-by-point or groups of points at a time. It is to be noted that this typed text conversion process does not rely on fonts. Also, as in FIG. 1A, the user at step 140 may decide to save the handwriting at step 150 or delete the handwriting at step 170. Furthermore, a user may retrieve a saved handwritten zPage at step 160, open another zBox or zPage, file or content and start the process again.

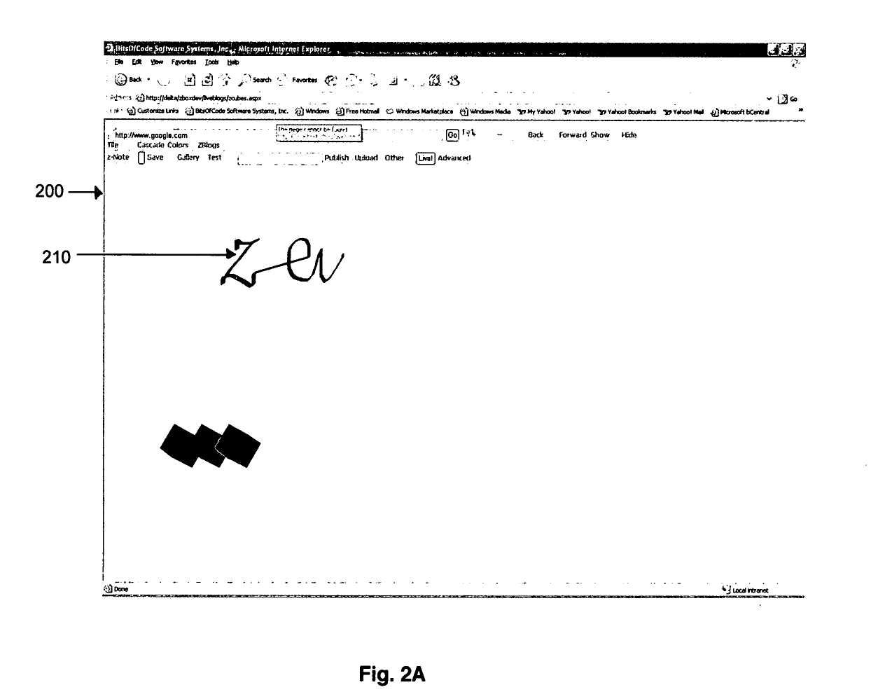

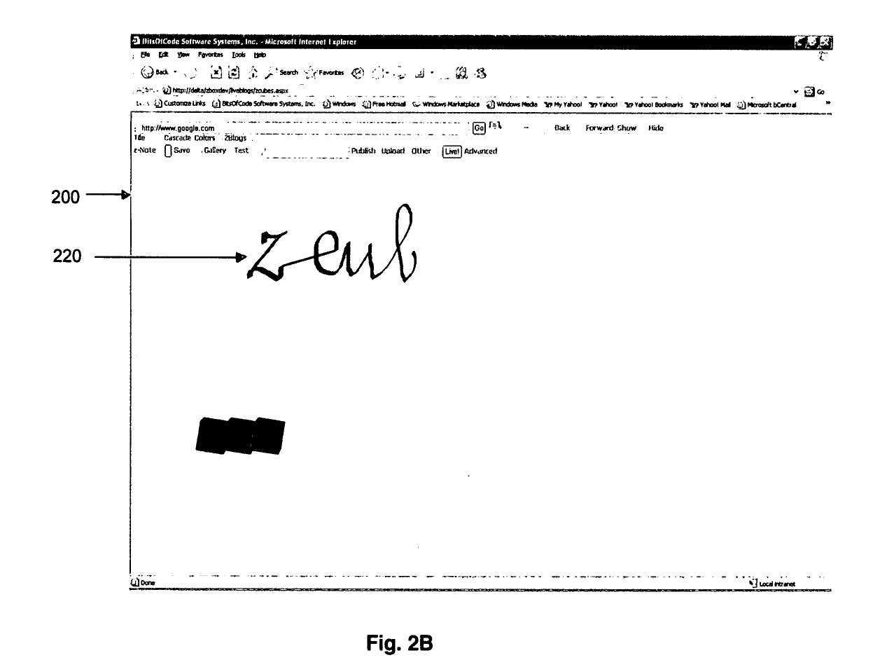

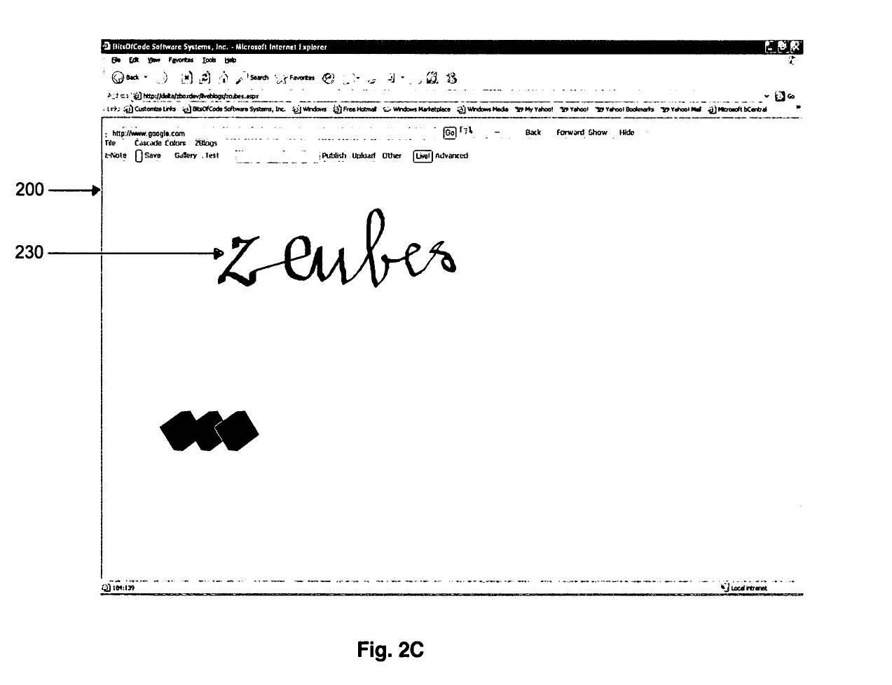

FIGS. 2A-2C demonstrate how the term “zcubes” is handwritten within a zPage. The points comprising the hidden handwritten VML object “zcubes” are released sequentially to ghost write “zcubes” within the zPage.

One skilled in the art will appreciate readily that the present invention is well adapted to carry out the objects and obtain the ends and advantages inherent herein. The present examples, along with the methods, procedures, systems, and/or applications described herein are presently representative of preferred embodiments, are exemplary and are not intended as limitations on the scope of the invention. Changes therein and other uses will occur to those skilled in the art which are encompassed within the spirit of the invention as defined by the scope of the claims.

What is claimed is:

1. A computer system, comprising:
a recursive web browser configured to recursively display one or more pages of content within a browser window thereof;
a device adapted for user-implemented handwriting or drawing; and
a unit for handwriting cursive script or drawing within the browser window.

2. The computer system of claim 1, wherein said device is a mouse, a stylus or a keyboard.

3. The computer system system of claim 1, further comprising means for launching a user-requested address or action.

4. The computer system of claim 3, wherein said means for launching a user-requested address or action is an action bar within the recursive browser window or an address bar located in a browser platform associated with the recursive web browser which triggers the action bar.

5. The computer system of claim 1, said handwriting unit comprising a process for storing a user-created handwriting or drawing object as a VML-, VRML- or SVG-formatted array representing points.

6. The computer system of claim 5, said unit further comprising a process for hiding the object.

7. The computer system of claim 6, said unit further comprising a process for time-releasing one or more points comprising the array as visible handwriting or drawing within a browser window.

8. The computer system of claim 5, further comprising a plurality of stored VML-, VRML- or SVG-formatted handwritings, said unit further comprising a process for mapping a typed text to said formatted handwritings.

9. The computer system of claim 8, wherein said typed text is a user-implemented typed text or retrieved typed text.

10. The computer system of claim 1, further comprising means for displaying said visible handwriting or drawing as a zPage or as a zBox or a combination thereof within the browser window.

11. The computer system of claim 1, further comprising means for saving said handwriting or drawing to a server, as a local file, or as an email.

12. A recursive browser system, comprising:
a recursive web browser configured to recursively display one or more pages of content within a browser window thereof; and
a unit for handwriting cursive script or drawing within the browser window.

13. The recursive browser system of claim 12, further comprising means for launching a user-requested address or action.

14. The recursive browser system of claim 13, wherein said means for launching a user-requested address or action is an action bar within the recursive browser window or an address bar located in a browser platform associated with the recursive web browser which triggers the action bar.

15. The recursive browser system of claim 12, said unit comprising:
a process for storing a user-created handwriting or drawing object as a VML-, VRML- or SVG -formatted array representing points;
a process for hiding the object; and
a process for time-releasing one or more points comprising the array as visible handwriting or drawing within a browser window.

16. The recursive browser system of claim 15, further comprising a plurality of stored VML-, VRML- or SVG-formatted handwritings, said unit further comprising a process for mapping a typed text to said formatted handwritings.

17. The recursive browser system of claim 16, wherein said typed text is a user-implemented typed text or a retrieved typed text.

18. The recursive browser system of claim 12, further comprising means for displaying said visible handwriting or drawing as a zPage or as a zBox or a combination thereof within the browser window.

19. The recursive browser system of claim 18, further comprising means for saving said handwriting or drawing to a server, as a local file, or as an email.

20. A recursive web browser, comprising:
a browser window configured to recursively display one or more pages of content therewithin;
means for launching a user-requested address or action; and
a unit for handwriting cursive script or drawing within the browser window.

21. The recursive web browser of claim 20, wherein said means for launching a user-requested address or action is an action bar within the recursive browser window or an address bar located in a browser platform associated with the recursive web browser which triggers the action bar.

22. The recursive web browser of claim 20, said unit comprising:
a process for storing a user-created handwriting or drawing object as a VML-, VRML- or SVG-formatted array representing points;
a process for hiding the object; and
a process for time-releasing one or more points comprising the array as visible handwriting or drawing within a browser window.

23. The recursive web browser of claim 22, further comprising a plurality of stored VML-, VRML- or SVG-formatted handwritings, said handwriting unit further comprising a process for mapping a typed text to said formatted handwritings.

24. The recursive web browser of claim 23, wherein said typed text is a user-implemented typed text or a retrieved typed text.

25. The recursive web browser of claim 12, further comprising means for displaying said visible handwriting or drawing as a zPage or as a zBox or a combination thereof within the browser window.

26. The recursive web browser of claim 25, further comprising means for saving said handwriting or drawing to a server, as a local file, or as an email.

27. A computer-implemented method for handwriting content in a recursive browser environment, comprising:
implementing a user-created handwriting object within the recursive browser window of claim 12,
storing the user-implemented handwriting object as a VML-, VRML- or SVG formatted array representing points;
hiding the handwriting object; and
time-releasing one or more points comprising the array as visible handwriting.

28. The computer-implemented method of claim 27, further comprising:
creating a plurality of VML-, VRML- or SVG formatted handwriting objects; and
mapping a typed text to said formatted handwriting objects.

29. The computer-implemented method of claim 28, wherein said typed text is a user-implemented typed text or a retrieved typed text.
